(19) United States
(12) Patent Application Publication
(10) Pub. No.: US 2014/0096160 A1
(43) Pub. Date: Apr. 3, 2014

(54) ELECTRONIC PROGRAM GUIDE DISPLAY METHOD AND SYSTEM

(71) Applicant: CHUNGHWA WIDEBAND BEST NETWORK CO., LTD., New Taipei City (TW)

(72) Inventor: Alan Chen, New Taipei City (TW)

(21) Appl. No.: 13/786,910

(22) Filed: Mar. 6, 2013

(30) Foreign Application Priority Data
Oct. 1, 2012 (TW) 101136272

(51) Int. Cl. H04N 21/482

(52) U.S. Cl. CPC H04N 21/482
USPC 725/45

(57) ABSTRACT

The present invention provides a computer-implemented method of displaying an electronic program guide, comprising: storing one or more program data of a program in a database; sorting the program into a category based on at least one of the one or more program data; associating the program with a property tag of the category, wherein the program data comprises title of the program, hosts, languages, length of the program, main actors, advertisement categories, source broadcasting channel of the program, and a combination thereof; and displaying a program guide of said category based on the property tag in the unit of individual programs.

### FIELD OF THE INVENTION

The present invention pertains to an electronic program guide display method and a system thereof.

### BACKGROUND OF THE INVENTION

In the prior art, a program (or program item) in a program guide is generally sorted by its broadcasting channel. For example, a program is sorted into a news category if its broadcasting channel is a news channel, and a program is sorted into a movie category if its broadcasting channel is a movie channel.

However, with the increasing number of TV channels and increasing diversity of TV programs, the above-described method has at least one shortcoming, i.e. failure to sort a program into a more appropriate or accurate category simply based on the source broadcasting channels. For instance, healthy, food, educational and political programs may broadcast on a news channel. A user cannot conveniently and accurately search the broadcast time or relevant information of a specific program of interest according to the above-described method.

Thus, there is still a need for an improved method or system of displaying a program guide to provide a more detailed program guide which is not restricted by the source broadcasting channels.

### BRIEF SUMMARY OF THE INVENTION

Accordingly, the present invention provides a computer-implemented method of displaying a more detailed electronic program guide which is not restricted by specific source broadcasting channels. On the other hand, the present invention also provides a system of displaying a more detailed electronic program guide which is not restricted by specific source broadcasting channels.

In one aspect, the present invention provides a computer-implemented method of displaying an electronic program guide, comprising: storing one or more program data of a program in a database; sorting the program into a category based on at least one of the one or more program data, wherein the program data comprises title of the program, hosts, languages, length of the program, main actors, advertisement categories, source broadcasting channel of the program, and a combination thereof; associating the program with a property tag of the category; and displaying a program guide of said category based on the property tag in the unit of individual programs.

The category may be selected from the group consisting of news, drama, health, life, political comments, sport, variety show, movie, shopping, religion, food, travel, science, education, culture, art, music and a combination thereof, and each property tag may correspond to one of the above-mentioned categories. In addition, the program may be sorted into a category through an algorithm.

In another aspect, the present invention provides a system for displaying an electronic program guide, comprising a server unit configured to, upon execution of computer readable instructions: storing one or more program data of a program in a database, sorting the program into a category based on at least one of the one or more program data, wherein the program data comprises title of the program, hosts, languages, length of the program, main actors, advertisement categories, source broadcasting channel of the program, and a combination thereof, and associating the program with a property tag of the category; and a user end for displaying a program guide of said category based on the property tag in the unit of individual programs.

In preferred embodiments of the present invention, the program is sorted into a category through an algorithm.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is an electronic program guide generated by an electronic program guide display method of the present invention.

FIG. 2 is another electronic program guide generated by an the electronic program guide display method of the present invention.

FIG. 3 is a diagram illustrating the electronic program guide display method according to one preferred embodiment of the present invention.

### DETAILED DESCRIPTION OF THE INVENTION

Unless defined otherwise, all technical and scientific terms used herein have the same meaning as commonly understood by a person skilled in the art to which this invention belongs. All publications mentioned herein are incorporated herein by reference to disclose and describe the methods and/or materials in connection with which the publications are cited.

As used herein, the singular forms “a”, “an”, and “the” include plural referents unless the context clearly dictates otherwise. Thus, for example, reference to “a sample” includes a plurality of such samples and equivalents thereof known to those skilled in the art.

In one aspect, the present invention provides a computer-implemented method of displaying an electronic program guide, comprising: storing one or more program data of a program in a database; sorting the program into a category based on at least one of the one or more program data, wherein the program data comprises title of the program, hosts, languages, length of the program, main actors, advertisement categories, source broadcasting channel of the program, and a combination thereof; associating the program with a property tag of the category; and displaying a program guide of said category based on the property tag in the unit of individual programs, wherein the program guide comprises a plurality of program items corresponding to a plurality of programs of the category respectively.

According to the present invention, the program data can be stored in a database and a program is sorted into a category based on at least one of the program data. Since each program independently has its own corresponding program data, the sorting is not restricted or limited by the source broadcasting channels.

The term “program data” as used herein refers to any data concerning the properties of the program. For example, program data includes but is not limited to title of the program, hosts, languages, length of the program, main actors, advertisement categories, source broadcasting channel of the program, broadcasting time and a combination thereof.

The category may be selected from the group consisting of news, drama, health, life, political comments, sport, variety show, movie, shopping, religion, food, travel, science, education, culture, art, music and a combination thereof. There may be one or more sub-category for a specific category. For example, the movie categories may comprise a comedy movie sub-category, an action movie sub-category and a drama movie sub-category.

The property tag indicates the category a program is sorted into. A program may be associated with one or more property tags. The property tag may be a property tag of news, drama, health, life, political comments, sport, variety show, movie, shopping, religion, food, travel, science, education, culture, art, music and a combination thereof. According to the present invention, a program may be associated with multiple property tags.

According to a preferred embodiment of the present invention, a program is sorted based on its program data through an algorithm. The program data may comprise title of the program, hosts, languages, length of the program, main actors, advertisement categories, source broadcasting channel of the program, broadcasting time and a combination thereof.

In one embodiment of the present invention, at least one of the one or more program data stored in a data base are substituted into an algorithm to sort the program into a category. For example, search and count specific keywords appear in the title and/or advertisement categories of a program to sort the program into one or more categories corresponding to the keywords that appear the most, e.g. if keywords “health” (a keyword corresponding to the health category) and “life” (a keyword corresponding to the life category) appear the most, the program is sorted into the health category and the life category, and then associated with the property tags of “health” and “life”.

As used herein, the term “algorithm” refers to an algorithm used for sorting as commonly understood by one of ordinary skill in the art. For example, a classifier based on supervised or unsupervised learning may be used.

In preferred embodiments of the present invention, the program guide may be displayed on a display device. The display device may show options of program categories. A user may choose the option of a specific category to display a program guide of said category on the display device. The display device includes but is not limited to a TV, a computer screen or a projecting screen.

In one preferred embodiment of the present invention, category options corresponding to a specific category respectively are displayed in the form of a square or rectangular array, e.g. a pound sign array or a 3-by-3 grid. In certain embodiments of the present invention, the category options are displayed in the form of a 3-by-3 square array or a 4-by-3 rectangular array.

Through sorting a program based on its variety of program data stored in a database, the present invention overcomes the problem of imprecise sorting in the prior art. For example, the prior art method will sort a cuisine program broadcasting on a new channel into the news category, while the method of the present invention will sort the cuisine program based on its relevant program data and sort it into, for example, the food category or the life category. Furthermore, a program may be associated with multiple property tags and thus belongs to multiple categories, providing more flexibility on the program sorting.

According to preferred embodiments of the present invention, the program guide shows multiple program items corresponding to multiple programs of a specific category respectively.

In one embodiment of the present invention, a user may select a category option to get a program guide of a category of interest, e.g. the food category. By selecting the category option of food category, the display device will then show a program guide comprising all programs that has been sorted into the food category.

In certain embodiments of the present invention, the order of the program items in the program guide is sorted according to broadcast time. In certain other embodiments, the order of the program items in the program guide may also be sorted according to popularity.

According to one preferred embodiment of the present invention, the program items in the program guide which are corresponding to currently broadcasting programs are specifically marked in a certain manner, for example, by an arrow, different color, flashing or boldface, allowing the user to easy recognize the currently broadcasting programs.

According to the present invention, the program item may also include an abstract of the corresponding program which may be display upon triggering of the user (e.g. selecting), allowing the user to find a program of interest more easily.

According to the present invention, the at least one of the one or more program data used to sort a program may also be manually chosen for sorting the program into a personal category and setting up a personal property tag. For example, for users of particularly interest of Japanese movies, they may choose program data of language being Japanese and program length being longer than 1 hour for program sorting through an algorithm, and set up a personal category of “Japanese movies” and a personal property tag of “Japanese movies.”

The present invention will now be described more specifically with reference to the following examples, which are provided for the purpose of demonstration rather than limitation.

### EXAMPLE 1

### Electronic Program Guide (1)

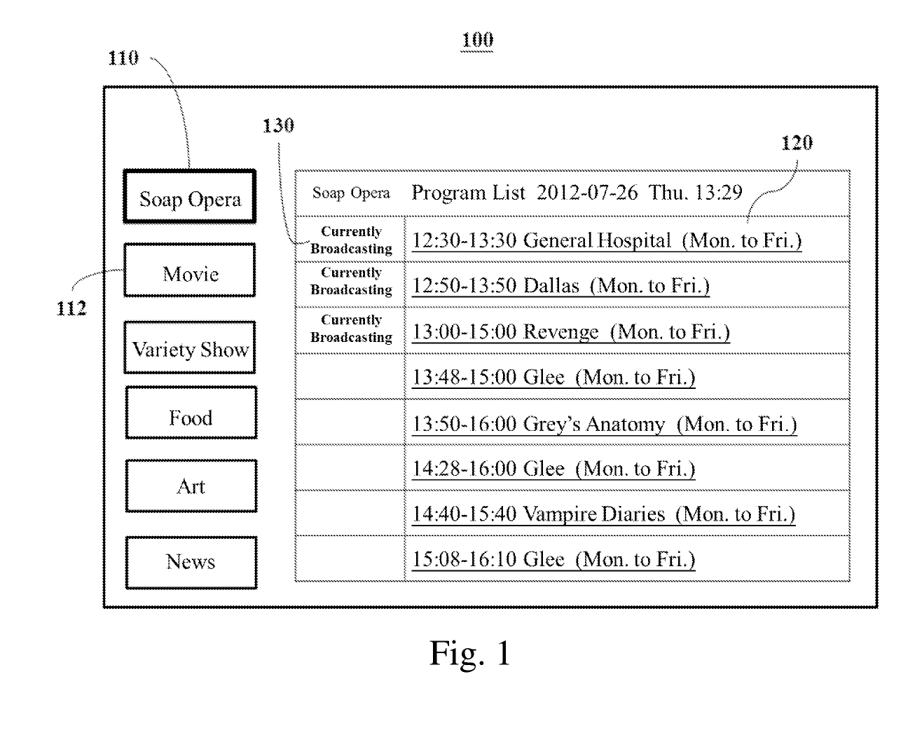

FIG. 1 illustrates an example of an electronic program guide generated by the electronic program guide display method of the present invention. As shown in the electronic program guide 100, category options (110 and 112), displaying on the left side, comprise soap opera, movie, variety show, food, art, and news. After selecting a category option (such as soap opera), a program list of the category displays on the right side. In this example, program items 120, corresponding to the programs having the property tags of the selected category, are sorted in order according to their broadcast time, wherein a program mark 130 of “currently broadcasting” is presented in front of the program item corresponding to the currently broadcasting program and a user can start to watch the program through selecting the program item.

### EXAMPLE 2

### Electronic Program Guide (2)

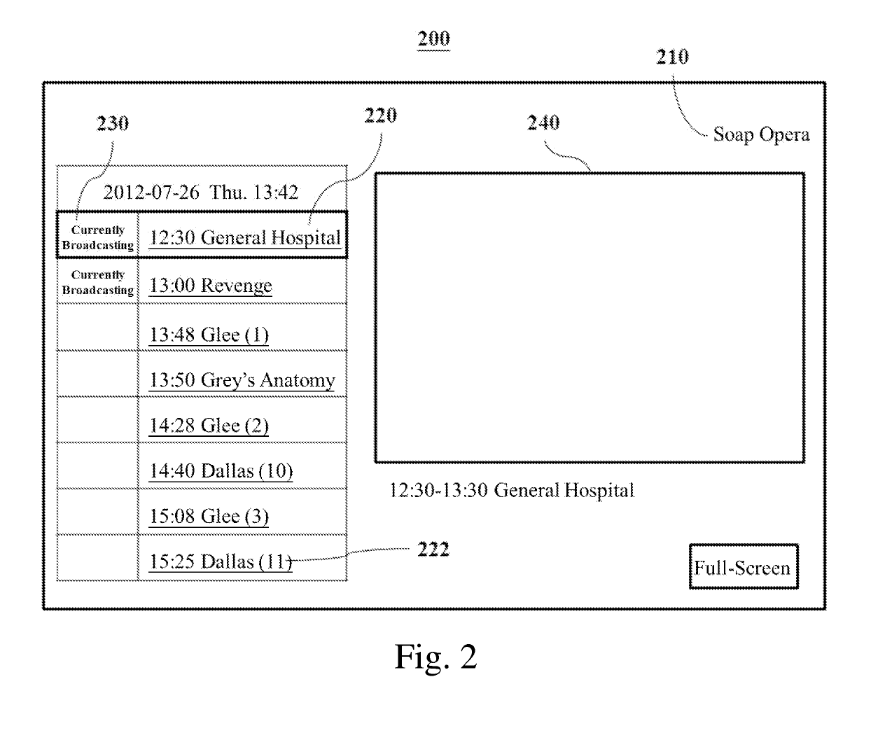

FIG. 2 illustrates another example of an electronic program guide generated by the electronic program guide display method of the present invention. In this example, program items, corresponding to programs with the property tags of the soap opera category, display with sorting according to broadcast time on left side of the electronic program guide 200, wherein a program mark 230 of “currently broadcasting” is presented in front of the program item 220 corresponding to the currently broadcasting program. In the electronic program guide, after selecting a program item corresponding to a currently broadcasting program, the real-time preview screen 240 is presented on right side of the electronic program guide and a user can start to watch the program in full-screen mode through selecting the full-screen item.

In another aspect, the present invention provide a system for displaying an electronic program guide, comprising: a server unit configured to, upon execution of computer readable instructions: storing one or more program data of a program in a database, sorting the program into a category based on at least one of the one or more program data, wherein the program data comprises title of the program, hosts, languages, length of the program, main actors, advertisement categories, source broadcasting channel of the program, and a combination thereof, and associating the program with a property tag of the category; and a user end for displaying a program guide of said category based on the property tag in the unit of individual programs.

The sever unit stores one or more program data of a program in a database and sorts a program into a category based on at least one of the program data. Since each program independently has its own corresponding program data, the sorting is not restricted or limited by the source broadcasting channels.

The user end may comprise a display device for displaying the program and the program guide. The term “display device” as used herein includes but is not limited to a TV, a computer screen or a projecting screen. According to the present invention, the display device may also display options of different functions in a form of a square or rectangular array to provide interactive services and functions.

The user end may also comprise a mediation module for communicating with the server unit. The mediation module may be, for example, a set-top box, a universal serial bus (USB) device, a mobile communication device or other similar devices. The mediation module may communicate with the sever unit via optical fiber networks, telephone data lines, wireless fidelity (Wi-Fi), 3.5G mobile communication, WiMAX or long term evolution (LTE) technologies.

According to a preferred embodiment of the present invention, a program is sorted based on its program data through an algorithm. The program data may comprise title of the program, hosts, languages, length of the program, main actors, advertisement categories, source broadcasting channel of the program, broadcasting time and a combination thereof. In one embodiment of the present invention, at least one of the one or more program data stored in a data base are substituted into an algorithm to sort the program into a category.

The category may be selected from the group consisting of news, drama, health, life, political comments, sport, variety show, movie, shopping, religion, food, travel, science, education, culture, art, music and a combination thereof. There may be one or more sub-category for a specific category. For example, the movie categories may comprise a comedy movie sub-category, an action movie sub-category and a drama movie sub-category. The property tag indicates the category a program is sorted into. A program may be associated with one or more property tags. The property tag may be a property tag of news, drama, health, life, political comments, sport, variety show, movie, shopping, religion, food, travel, science, education, culture, art, music and a combination thereof. According to the present invention, a program may be associated with multiple property tags.

In one preferred embodiment of the present invention, category options corresponding to a specific category respectively are displayed in the form of a square or rectangular array, e.g. a pound sign array or a 3-by-3 grid. In certain embodiments of the present invention, the category options are displayed in the form of a 3-by-3 square array or a 4-by-3 rectangular array.

Users may use a remote or simply touch the screen of the display device to control the user end. Accordingly, the user end may further comprise a remote module. The remote module transmits commands to the mediation module through transmission mediums such as infrared rays (IR), radio frequency (RF), wireless fidelity (Wi-Fi) or other suitable transmission mediums.

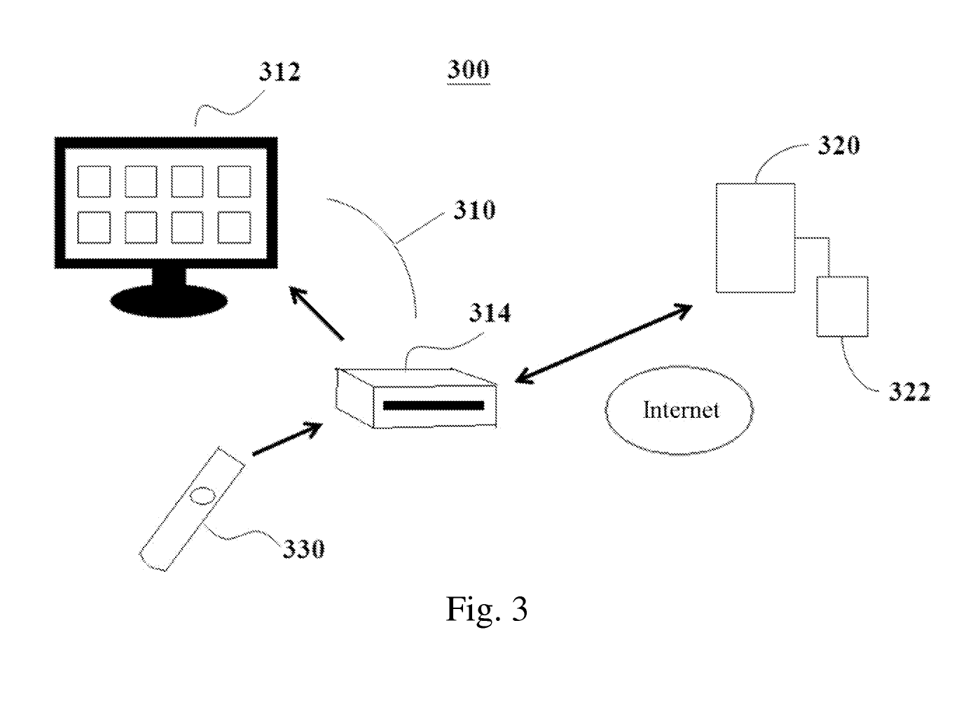

FIG. 3 illustrates a preferred embodiment of the electronic program guide display system of the present invention, comprising: a user end 310 including a display device 312 and a mediation module 314, wherein the display device is accommodated to display a program guide and the mediation module, connected between the display device 312 and a server unit 320, is adapted to receive a user's command and pass a server certification; a server unit 320 storing program data of a program in a database 322, sorting the program into a category based on at least one of the one or more program data, wherein the program data comprises title of the program, hosts, languages, length of the program, main actors, advertisement categories, source broadcasting channel of the program, and a combination thereof; and associating the program with a property tag of the category; and a remote module 330.

What is claimed is:

1. A computer-implemented method of displaying an electronic program guide, comprising:
storing one or more program data of a program in a database;
sorting the program into a category based on at least one of the one or more program data;
associating the program with a property tag of the category, wherein the program data comprises title of the program, hosts, languages, length of the program, main actors, advertisement categories, source broadcasting channel of the program, and a combination thereof; and
displaying a program guide of said category based on the property tag in the unit of individual programs.

2. The method of claim 1, wherein the category is selected from the group consisting of news, drama, health, life, political comments, sport, variety show, movie, shopping, religion, food, travel, science, education, culture, art, music and a combination thereof.

3. The method of claim 1, wherein the program associates with a plurality of property tags.

4. The method of claim 1, wherein the program is sorted into a category through an algorithm.

5. The method of claim 4, wherein the program is sorted into a category by substituting at least one of the one or more program data into the algorithm.

6. The method of claim 1, wherein the one or more program data of a program are chosen by a user for sorting the program into a personal category and setting up a personal property tag.

7. The method of claim 1, wherein the program guide displays a plurality of program items corresponding to a plurality of programs of the category respectively.

8. The method of claim 7, wherein the plurality of program items are sorted according to broadcast time.

9. The method of claim 7, wherein the program item corresponding to a currently broadcasting program is specifically marked.

10. The method of claim 7, wherein the program item comprises an abstract of the corresponding program.

11. A system for displaying an electronic program guide, comprising:
a server unit configured to, upon execution of computer readable instructions: storing one or more program data of a program in a database; sorting the program into a category based on at least one of the one or more program data, wherein the program data comprises title of the program, hosts, languages, length of the program, main actors, advertisement categories, source broadcasting channel of the program, and a combination thereof; and associating the program with a property tag of the category; and
a user end for displaying a program guide of said category based on the property tag in the unit of individual programs.

12. The system of claim 11, wherein the program is sorted into a category through an algorithm.

13. The system of claim 12, wherein the program is sorted into a category by substituting at least one of the one or more program data into the algorithm.

14. The system of claim 11, wherein the one or more program data of a program are chosen by a user for sorting the program into a personal category and setting up a personal property tag.
